(19) United States
(12) Patent Application Publication
(10) Pub. No.: US 2025/0155577 A1
(43) Pub. Date: May 15, 2025

(54) THREE-DIMENSIONAL DISTANCE INFORMATION ACQUISITION DEVICE AND ELECTRONIC DEVICE INCLUDING THE SAME

(71) Applicant: Samsung Electronics Co., Ltd., Suwon-si, Gyeonggi-do (KR)

(72) Inventors: Wontaek SEO, Suwon-si (KR); Young KIM, Suwon-si (KR); Byunggil JEONG, Suwon-si (KR); Junghyun PARK, Suwon-si (KR); Jangwoo YOU, Suwon-si (KR)

(73) Assignee: Samsung Electronics Co., Ltd., Suwon-si, Gyeonggi-do (KR)

(21) Appl. No.: 18/623,643

(22) Filed: Apr. 1, 2024

(30) Foreign Application Priority Data
Nov. 13, 2023 (KR) 10-2023-0156322

(51) Int. Cl. G01S 17/894; G01S 7/481; G01S 7/484

(52) U.S. Cl. CPC G01S 17/894; G01S 7/4814; G01S 7/4816; G01S 7/4817; G01S 7/484

(57) ABSTRACT

A three-dimensional distance information acquisition device includes a transmitter, a receiver, and a controller configured to acquire three-dimensional distance information of a scan area from a detection signal of a photodetector by controlling the transmitter and receiver. The receiver includes a receiving optical system configured to have condensing power in a first direction greater than condensing power in a second direction and condense light reflected from the scan area and incident, within a first range in the first direction, and a photodetector having a light receiving area to detect the light condensed within the first range, and configured to collect the light reflected from the scan area by using the receiving optical system, and receive the light in at least one light receiving area in the first direction.

### CROSS-REFERENCE TO RELATED APPLICATION

This application is based on and claims priority under 35 U.S.C. § 119 to Korean Patent Application No. 10-2023-0156322, filed on Nov. 13, 2023, in the Korean Intellectual Property Office, the disclosure of which is incorporated by reference herein in its entirety.

### BACKGROUND

Various example embodiments relate to a three-dimensional distance information acquisition device and/or an electronic device including the three-dimensional distance information acquisition device.

In order to acquire a three-dimensional image, light emitted from a light source of a transmitter is irradiated to a scan area, the light reflected and returned from a target object is detected by a light receiving element of a receiver, and a distance is measured by using a difference between the time when a signal is detected and the time when the light is emitted from the transmitter.

In order to satisfy or at least partially satisfy the resolution for identifying a target object in the field of view, the light receiving element comprises a large number of pixels corresponding to pixels for a target resolution. The large number of pixels increase the complexity of circuits around the light receiving element, and accordingly, volumes of a form factor and/or of a corresponding peripheral circuit and memory increase, and/or more computing power is consumed. In particular, as the resolution increases, the trend is more severe.

### SUMMARY

Provided are a three-dimensional distance information acquisition device that may reduce a form factor of a photodetector and/or a corresponding peripheral circuit and memory, and/or may greatly reduce computing power. Alternatively or additionally, provided is an electronic device including the three-dimensional distance information acquisition device.

Additional aspects will be set forth in part in the description which follows and, in part, will be apparent from the description, or may be learned by practice of various example embodiments.

According to an aspect of the disclosure, a three-dimensional distance information acquisition device includes a transmitter configured to irradiate light to a scan area, scan the scan area in time division in a first direction, and irradiate light in at least one of a point unit or line unit in a second direction orthogonal to the first direction, a receiver including a receiving optical system configured to have condensing power in the first direction greater than condensing power in the second direction and to condense light reflected from the scan area and incident, within a first range in the first direction, and a photodetector having a light receiving area configured to detect the light condensed within the first range and configured to collect the light reflected from the scan area by using the receiving optical system and to receive the light to at least one light receiving area in the first direction, and a controller configured to acquire three-dimensional distance information of the scan area from a detection signal of the photodetector by controlling the transmitter and the receiver.

### BRIEF DESCRIPTION OF THE DRAWINGS

The above and other aspects, features, and advantages of certain example embodiments will be more apparent from the following description taken in conjunction with the accompanying drawings, in which:

FIGS. 1 and 2 illustrate a relationship between a scan area and a photodetector that detects light reflected from a target object in the scan area in a three-dimensional distance information acquisition device according to some example embodiments;

FIG. 3A is a schematic diagram illustrating a three-dimensional distance information acquisition device according to some example embodiments;

FIG. 3B illustrates an optical path for detecting reflected light in time division in a ratio of N:1 for N resolution pixels when light emitted from a transmitter is irradiated to a scan area in time division in the device of FIG. 3A;

FIG. 4A is a schematic diagram illustrating a three-dimensional distance information acquisition device according to some example embodiments;

FIG. 4B illustrates an optical path for detecting reflected light in time division in a ratio of N:1 for N resolution pixels in synchronization with light steering when light steered by a transmitter is emitted and irradiated to a scan area in time division in the device of FIG. 4A;

FIG. 5A illustrates a path of light, which is reflected from a target object in a scan area and input to a receiver, in a plane parallel to a second direction, that is, a longitudinal direction (the x-axis direction);

FIG. 5B illustrates a path of light, which is reflected from a target object in a scan area and input to a receiver, in a plane parallel to a first direction, that is, a scan direction (the y-axis direction);

FIG. 6 illustrates a comparison between a three-dimensional distance information acquisition device of Embodiment Example 1 and a three-dimensional distance information acquisition device of Comparative Example 1, which have the same transmitter but a difference in receiver;

FIG. 7 illustrates a comparison between a three-dimensional distance information acquisition device of Embodiment Example 2 and a three-dimensional distance information acquisition device of Comparative Example 2, which have the same transmitter but a difference in receiver;

FIG. 8A is a cross-sectional view illustrating a schematic example of a spatial light modulator that may be applied to a three-dimensional distance information acquisition device according to some example embodiments as a steering element;

FIG. 8B is a plan view of one pixel of the spatial light modulator of FIG. 8A;

FIG. 9 is a graph illustrating a distribution of emitted light according to a method of driving a spatial light modulator;

FIGS. 10 and 11 illustrate beam steering performed by a transmitter of a three-dimensional distance information acquisition device according to some example embodiments;

FIG. 12A illustrates an example of an optical configuration of a receiver of a three-dimensional distance information acquisition device according to some example embodiments;

FIG. 12B illustrates a perspective view of the optical configuration of FIG. 12A;

FIG. 13 illustrates an example of a photodetector that may be applied to a three-dimensional distance information acquisition device according to various embodiments;

FIG. 14 illustrates another example of an optical configuration of a receiver of a three-dimensional distance information acquisition device according to some example embodiments;

FIG. 15 illustrates another example of an optical configuration of a receiver of a three-dimensional distance information acquisition device according to some example embodiments;

FIG. 16 illustrates schematic time-division signal processing of two pieces of line scanning;

FIGS. 17A and 17B are respectively a side view and a plan view illustrating a design example of a receiving optical system according to some example embodiments;

FIG. 18 is a plan view illustrating a design example of a receiving optical system according to some example embodiments;

FIGS. 19A to 19D illustrate various lenses that may be used as a condensing lens of a receiving optical system of a three-dimensional distance information acquisition device according to some example embodiments;

FIG. 20 is a conceptual diagram illustrating a case where a three-dimensional distance information acquisition device according to some example embodiments is applied to a mobile device; and

FIGS. 21A and 21B are conceptual diagrams illustrating a case where a three-dimensional distance information acquisition device according to some example embodiments is applied to a vehicle.

### DETAILED DESCRIPTION

Reference will now be made in detail to various embodiments, some examples of which are illustrated in the accompanying drawings, wherein like reference numerals refer to like elements throughout. In this regard, the present embodiments may have different forms and should not be construed as being limited to the descriptions set forth herein. Accordingly, embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, some example embodiments will be described in detail with reference to the accompanying drawings. In the following drawings, the same reference numerals refer to the same components, and a size of each component in the drawings may be exaggerated for the sake of clear and convenient description. In addition, the following embodiments to be described are merely examples, and various modifications may be made from the embodiments.

Hereinafter, what is described as “upper portion” or “on or upper” may also include not only components directly thereon, thereunder, on the left, and on the right in contact therewith but also components thereon, thereunder, on the left, and on the right without being in contact therewith. Singular expressions include plural expressions unless the context clearly indicates otherwise. In addition, when a portion “includes” a certain component, this means that other components may be further included rather than excluding other components unless specifically stated to the contrary.

Use of a term “the” and similar reference terms may correspond to both the singular and the plural. Steps constituting a method may be performed in any suitable order unless there is a clear statement that the steps should be performed in the order described or contrary to the order and are not limited thereto.

In addition, terms such as “ . . . unit”, “ . . . portion”, and “module” described in the specification mean units that process at least one function or operation, which may be implemented as hardware or software, or as a combination of hardware and software.

Connection or connection members of lines between configuration elements illustrated in the drawings exemplarily represent functional connections and/or physical or circuit connections and may be represented as alternative or additional various functional connections, physical connections, or circuit connections in an actual apparatus.

Use of all examples or all example terms is merely for describing technical ideas in detail, and the scope of claims is not limited by the examples or the example terms unless limited by the claims.

A three-dimensional (3D) distance information acquisition device according to some example embodiments includes a receiver that may detect light for N resolution pixels (where N is an integer of 2 or more) in a ratio of N:1 along a scan direction of an object space compared to, for example, the known receiver (Rx) system corresponding 1:1 to the multiple resolution pixels so as to identify a target object in a range of a field of view (FOV). Accordingly, it may be possible to provide a 3D distance information acquisition device that may reduce a form factor of a photodetector and of corresponding peripheral circuits and memory, and/or may greatly reduce computing power. Alternatively or additionally, it may be possible to provide an electronic device including the 3D distance information acquisition device.

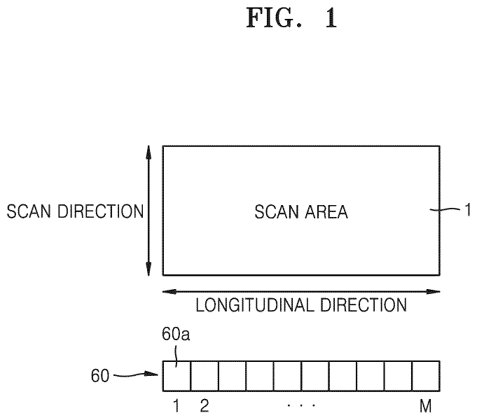

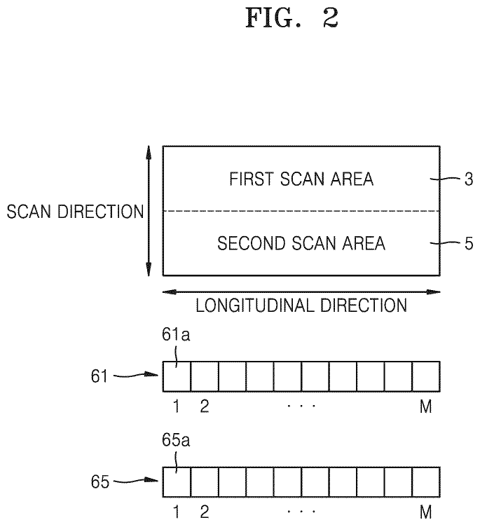

FIGS. 1 and 2 illustrate a relationship between a scan area and a photodetector that detects light reflected from a target object in the scan area in a 3D distance information acquisition device according to some example embodiments.

As illustrated in FIG. 1, the 3D distance information acquisition device according to some example embodiments may scan a scan area 1 corresponding to a range of field of view in a time division in N resolution pixels by scanning along a first direction, for example, a scan direction by using at least one scan beam. The 3D distance information acquisition device may detect the light reflected from the scan area 1 in time division in a ratio of N:1 for the N resolution pixels of the scan area 1, and may acquire distance information about a target object or depth information about the target object and an environment. Here, N may be an integer of 2 or more. Here, the scan area 1 and a plurality of scan areas 3 and 5 to be described below are object spaces, and although a transmitter scans a two-dimensional plane, a 3D space is actually scanned.

Also, as illustrated in FIG. 2, the 3D distance information acquisition device according to some example embodiments may divide a scan area corresponding to the range of field of view into the plurality of scan areas 3 and 5, scan the respective scan areas 3 and 5 in time division in N′ resolution pixels in a first direction, for example, a scan direction by using at least one scan beam, detect the light reflected from the respective scan areas 3 and 5 in time division of N′: 1 for the N′ resolution pixels of the respective scan areas 3 and 5, and acquire distance information about a target object or depth information about the target object and an environment. Here, N′ is an integer of 2 or more and may be the same as or different from (greater than or less than) N. For example, the number of resolution pixels implemented for each scan areas 3 and 5 when the range of field of view is divided into a plurality of scan areas 3 and 5 may be equal to or different from the number of resolution pixels when the entire range of field of view is considered as one scan area 1. Hereinafter, for the sake of convenience of description, the number of resolution pixels obtained by scanning the scan areas 1, 3, and 5 in time division in the first direction, for example, a scan direction, is referred to as N regardless of the number of scan areas in which the range of field of view is scanned.

In this way, the 3D distance information acquisition device according to some example embodiments may consider a scan area (an object space) of a range of field of view as one scan area 1 or may divide the scan area into a plurality of scan areas 3 and 5, scan the scan area 1, 3, and 5 in time division in N resolution pixels in a scan direction, detect the light reflected from the scan areas 1, 3, and 5 in time division in a ratio of N:1 for the N resolution pixels of the scan areas 1, 3, and 5, and acquire distance information about a target object and/or depth information about the target object and an environment.

Also, the 3D distance information acquisition device according to some example embodiments may detect the light reflected from the scan area 1 in M resolution pixels in a second direction, for example, a longitudinal direction, where M is an integer of 1 or more. In this case, light may be irradiated in point units and/or in line units in the longitudinal direction. Here, even when the light is irradiated in point units in the longitudinal direction, one line is formed over a certain period of time by irradiating light in point units in the longitudinal direction for two-dimensional plane scanning, and accordingly, it may take time to form one line. Therefore, when light is irradiated in point units, scanning in the scan direction may be performed, for example, at time intervals for forming one line.

For example, as illustrated in FIG. 1, the 3D distance information acquisition device according to some example embodiments may be provided to scan the scan area 1 in a range of field of view in time division in N resolution pixels in the scan direction, and may acquire information about the scan area 1 of M resolution pixels by using M light receiving areas 60a in the longitudinal direction and information about the scan area 1 of N resolution pixels in time division by using one light receiving area 60a in the scan direction. For example, a receiver may include one photodetector 60 having M light receiving areas 60a arranged in a one-dimensional array in a second direction, that is, the longitudinal direction.

In some other examples, as illustrated in FIG. 2, the 3D distance information acquisition device according to some example embodiments may be provided to divide a range of field of view into the first scan area 3 and the second scan area 5, scan each of the first scan area 3 and the second scan area 5 in time division in N resolution pixels in the scan direction, and acquire information about the first scan area 3 and information about the second scan area 5 of M resolution pixels by using M light receiving areas 61a and 65a one-dimensionally arranged in the longitudinal direction and N resolution pixels for each light receiving area in time division by using two light receiving areas 61a and 65a separated from each other in the scan direction. For example, the receiver may include, for example, a first photodetector 61 receiving the light which is reflected from the first scan area 3 corresponding to a first position in a scan direction and condensed by a receiving optical system, and a second photodetector 65 receiving the light which is reflected from the second scan area 5 corresponding to a second position in the scan direction and condensed by the receiving optical system. In addition, the first photodetector 61 and the second photodetector 65 may each include M light receiving areas 61a and 65a arranged in a one-dimensional array in the second direction.

In another example, the 3D distance information acquisition device according to some example embodiments may be provided to divide a range of field of view into first to S scan areas (where S is an integer of 2 or more), scan each of the first to S scan areas in time division in N resolution pixels in a scan direction, and acquire scan area information of M resolution pixels by using M light receiving areas arranged one-dimensionally in a longitudinal direction and N resolution pixels for each light receiving area in time division by using S light receiving areas separated from each other in the scan direction. That is, the receiving optical system and photodetector of the receiver may be provided to receive the light which is reflected from the first to S^{th} scan areas and condensed by the receiving optical system at first to S^{th} photodetectors. In this case, the first to S^{th} photodetectors may each include M light receiving areas arranged in a one-dimensional array in the longitudinal direction. Some example embodiments of FIG. 2 corresponds to a case in which S=2.

In this way, the 3D distance information acquisition device according to some example embodiments may be provided to scan the scan area 1 in time division in N resolution pixels in the first direction, that is, the scan direction, thereby acquiring distance information of a target object or depth information about the target object and an environment, where N corresponds to an integer of 2 or more. Also, the 3D distance information acquisition device according to some example embodiments may be provided to detect the light reflected from the scan area 1 in M resolution pixels in the second direction, for example, the longitudinal direction, where M corresponds to an integer of 1 or more. In this case, light may be irradiated in point unit or line unit in the longitudinal direction. The scan area may be single scan area 1, and in this case, the photodetector 60 having the M light receiving areas arranged one-dimensionally may be used. Also, scanning may be performed by dividing the scan area into S scan areas, for example, the first and second scan areas 3 and 5 in the first direction, and in this case, S photodetectors, each having M light receiving areas arranged one-dimensionally, such as the first and second photodetectors 61 and 65, may be used.

The 3D distance information acquisition device according to some example embodiments may be applied as a distance sensor, a 3D sensor, a lidar sensor, and so on to acquire distance information or a 3D image.

Hereinafter, a case, in which the 3D distance information acquisition device according to some example embodiments may be provided to scan the entire range of field of view as one scan area in time division in N resolution pixels in the scan direction as illustrated in FIG. 1, or divide the range of field of view into the first and second scan areas 3 and 5 and scan each of the first and second scan area 3 and 5 in time division in N resolution pixels in the scan direction, and detect the light reflected from each scan area in M resolution pixels in the longitudinal direction, is described as an example. However, the disclosure is not limited thereto.

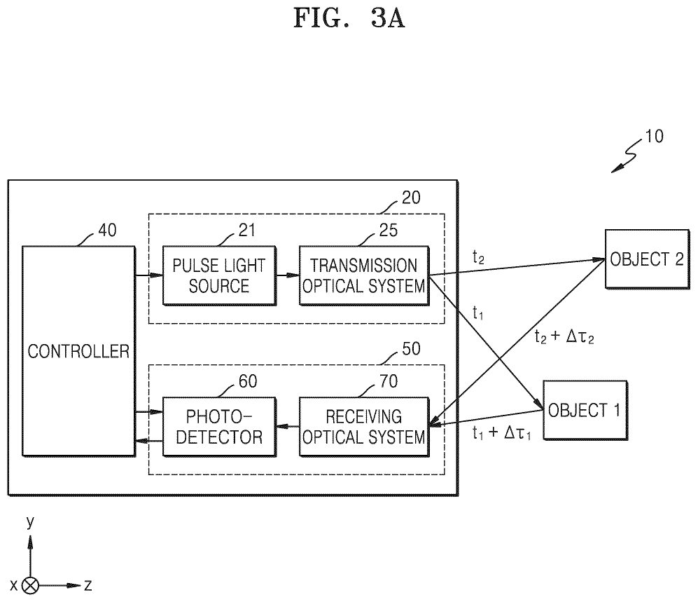

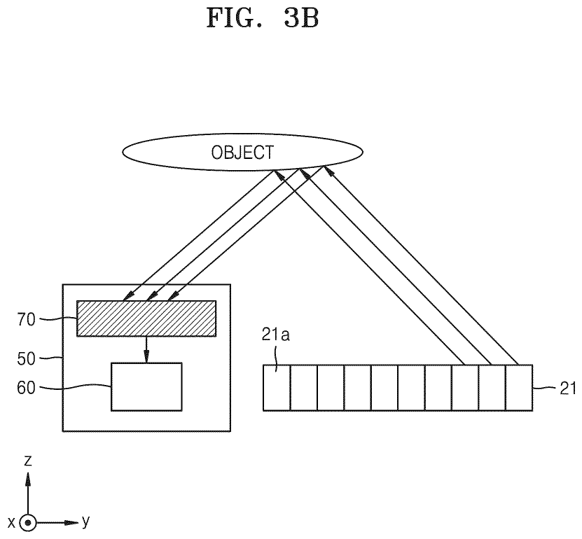

FIG. 3A is a schematic diagram illustrating a 3D distance information acquisition device 10 according to some example embodiments, and FIG. 3B illustrates an optical path for detecting the reflected light in time division in a ratio of N:1 for N resolution pixels when the light emitted from a transmitter is irradiated to a scan area in time division in 3D distance information acquisition device 10 of FIG. 3A.

Referring to FIGS. 3A and 3B, the 3D distance information acquisition device 10 according to some example embodiments may include a transmitter 20 that irradiates light to a scan area and scans the scan area in time division in a scan direction (a y-axis direction), a receiver 50 including a receiving optical system 70 and a photodetector 60, and a controller 40 that controls the transmitter 20 and the receiver 50 to acquire 3D distance information or depth information from a detection signal of the photodetector 60.

The transmitter 20 may irradiate light to a scan area, scan the scan area in time division in a first direction (the y-axis direction), for example, a scan direction, and irradiate light in point unit or line unit in a second direction (the x-axis direction) perpendicular to the first direction, for example, a longitudinal direction. The transmitter 20 includes a light source 21 that emits light and a transmission optical system 25 that causes the light emitted from the light source 21 to be irradiated to a scan area 1.

The light source 21 may be provided as a pulsed light source. The light source 21 may emit, for example, visible light and/or near-infrared light of a bandwidth of about 800 nm to about 1700 nm. The light source 21 may include, for example, a laser light source driven to output pulse light. The light source 21 may include at least one semiconductor laser, for example, a plurality of semiconductor laser arrays, to output pulse light of desired power. The pulse light of desired power may be output by turning on/off all or part of a plurality of semiconductor laser arrays. A semiconductor laser, which is applied as the light source 21, may include any one or more of, for example, an edge emitting laser (EEL), a vertical cavity surface emitting laser (VCSEL), and a photonic crystal surface emitting laser (PCSEL).

In this way, the light source 21 may be provided to include at least one semiconductor laser and use as a flash semiconductor light source that outputs pulsed light. For example, the light source 21 may include a plurality of VCSEL arrays, and the plurality of VCSEL arrays may be used as a flash VCSEL light source to output pulse light.

As illustrated in FIGS. 3A and 3B, the transmitter 20 may be provided to scan the scan area 1 in time division in a scan direction (the y-axis direction) by driving only the light source 21.

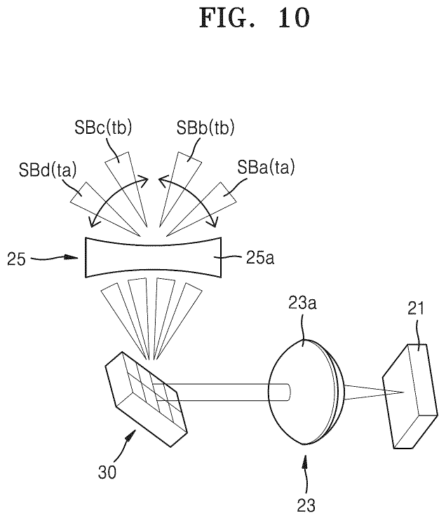

For example, the light source 21 may include a plurality of light source elements 21a arranged in a two-dimensional array, and each light source element 21a may include at least one semiconductor laser. For example, the transmission optical system 25 may include a collimating lens (e.g., 23a in FIG. 10) for collimating the light emitted from the light source 21 and may further include at least one concave lens (e.g., 25a in FIG. 10).

For example, when scanning the scan area in time division in N resolution pixels by driving only the light source 21, the light source 21 may include an array of N light source elements 21a arranged in a scan direction (the y-axis direction), and each light source element 21a may be driven to sequentially emit light in time division. Alternatively or additionally, the light source 21 may include one light source element or an array of light source elements less than M light source elements or an array of M light source elements or more in a longitudinal direction (the x-axis direction).

The light source 21 may be provided to irradiate light in a direction perpendicular to the scan direction, for example, in the longitudinal direction (the x-axis direction) such that light may be irradiated to the scan area corresponding to a two-dimensional plane during one scan. For example, each light source element 21a may be provided to emit light in line unit or in unit of one or more points in the longitudinal direction. For example, each light source element 21a may include multiple sub-light source elements, such as multiple sub-semiconductor lasers, located on the same line in the longitudinal direction (the x-axis direction), drive one or more sub-light source elements located on the same line in the longitudinal direction (the x-axis direction) sequentially or all together to irradiate light to the scan area 1 in unit of one or more points or line unit, and at the same time, change the line on which the light source elements 21a are turned on in the scan direction (the y-axis direction) such that the scan area 1 may be scanned in time division. As a result, the line light may be irradiated to the scan area for a certain period of time, and/or the line light may be irradiated at a single moment, and a position at which the line light is irradiated is changed in time division, and accordingly, the scan area may be scanned.

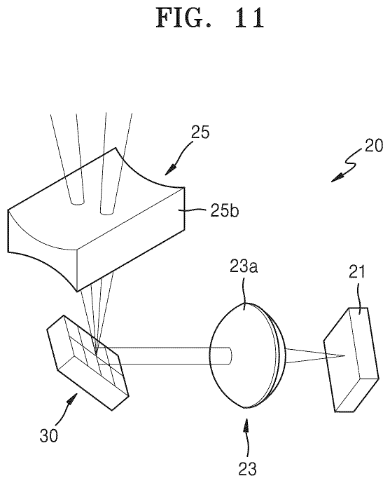

Alternatively or additionally, the light source 21 may include a plurality of light source elements 21a arranged in a one-dimensional array, and each light source element 21a may include at least one semiconductor laser, and the transmission optical system 25 may be configured to making the light emitted from one light source element into line light in the longitudinal direction (the x-axis direction). To this end, the transmission optical system 25 may include, for example, a collimating lens (e.g., 23a in FIG. 11) for collimating the light emitted from the light source 21, a cylinder lens (e.g., 25b in FIG. 11) for making a line beam, and so on. In this case, when the plurality of light source elements 21a arranged in a one-dimensional array are sequentially driven, a position at which line light is irradiated to a scan area may be sequentially changed in the scan direction (the y-axis direction). As a result, the position at which the line light is irradiated may be changed in time division, and thus the scan area may be scanned in time division with the line light in the scan direction (the y-axis direction).

As described with reference to FIGS. 3A and 3B, the transmitter 20 may be provided to irradiate light to a scan area in point units and/or line units. To this end, the light source 21 may have a structure in which the plurality of light source elements 21a are arranged in a two-dimensional array or a one-dimensional array and may be driven to irradiate light in point unit or line unit under control by the controller 40.

For example, the light source 21 may include a plurality of VCSELs arranged in a two-dimensional array, and a plurality of VCSELs in line units may be used as a flash VCSEL light source to output pulse light. The flash VCSEL may include a plurality of VCSELs, and may indicate that the plurality of VCSELs are turned on or off simultaneously to output flash light, for example, pulse light. While the flash VCSEL may not turn individual VCSELs on or off, a fill factor increases in terms of VCSEL production, and the level of quality requirements or expectations for the entire light source is lowered, resulting in high yield, and accordingly, a price of the applied light source may be reduced.

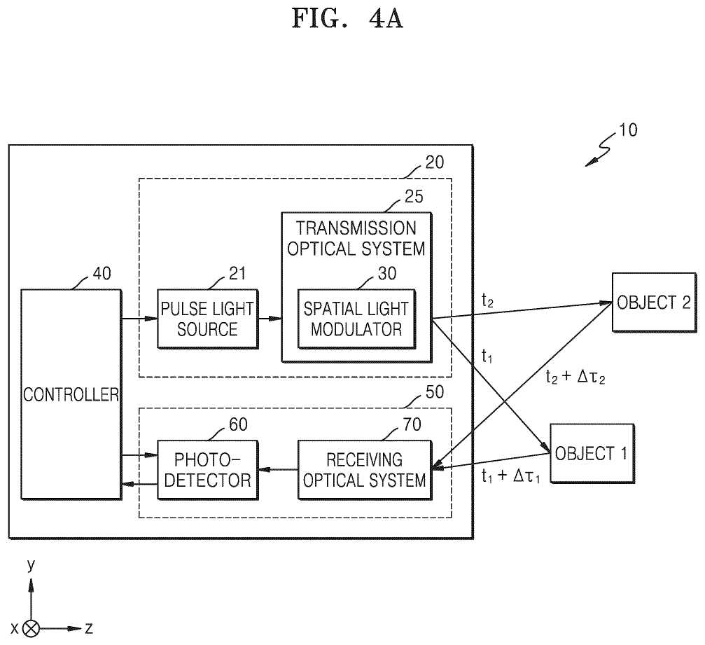

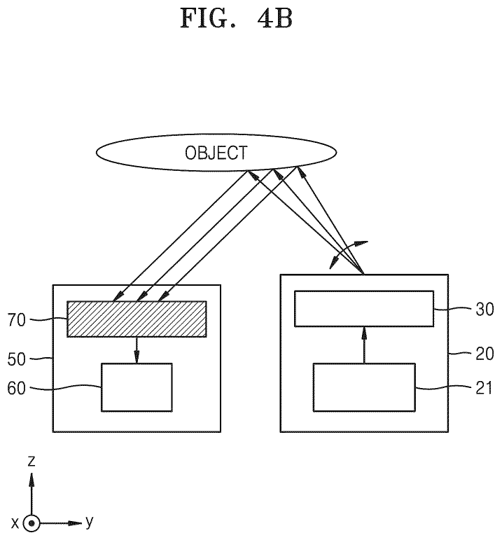

Alternatively or additionally, the transmitter 20 may be provided to scan the scan area 1 in the scan direction (the y-axis direction) in time division by steering light as illustrated in FIGS. 4A and 4B. FIG. 4A is a schematic diagram illustrating a 3D distance information acquisition device according to some example embodiments, and FIG. 4B illustrates an optical path for detecting the reflected light in time division in a ratio of N:1 for N resolution pixels in synchronization with the light steering when the light steered by a transmitter is emitted and irradiated to a scan area in time division in the device of FIG. 4A.

In various example embodiments of FIGS. 4A and 4B, a light source 21 has a configuration corresponding to one light source element or an array of a plurality of light source elements 21a arranged one-dimensionally in a longitudinal direction (the x-axis direction) in various example embodiments of FIGS. 3A and 3B, and a transmission optical system 25 may include a steering element, such as a spatial light modulator 30 to steer the light incident from the light source 21 and scan a scan area in a scan direction (the y-axis direction) in time division.

For example, the light source 21 may include a plurality of VCSELs arranged one-dimensionally and may drive each VCSEL or use all of the plurality of VCSELs forming a line as a flash VCSEL light source to output pulse light. A steering element may include, for example, a spatial light modulator 30 including a plurality of pixels for steering incident light by phase modulation. Here, it may be difficult to apply a beam steering method based on mechanical rotation to a mobile device and so on to acquire distance information or a 3D image, due to a form factor limitation which requires, for example, a thickness that is less than a few mm. Alternatively or additionally, a beam steering method based on micro electro-mechanical system (MEMS) is vulnerable to an external shock and/or vibration, and accordingly, it may be difficult for the beam steering method to be applied to mobile devices or vehicles. The 3D distance information acquisition device according to some example embodiments applies the spatial light modulator 30 as a steering element, and thus, there is no or a reduced difficulty in form factor limitations, and the 3D distance information acquisition device is not affected or is less affected by an external shock and/or vibration and may be applied to mobile devices and/or to vehicles as one or more of a distance sensor, a 3D sensor, a lidar sensor, or so on.

The spatial light modulator 30 may include a plurality of pixels to steer incident light by phase modulation. Here, a pixel may represent the smallest unit independently driven by the spatial light modulator 30 or a basic unit capable of independently modulating a phase of light. The spatial light modulator 30 may have a structure in which pixels are arranged one-dimensionally or two-dimensionally, and each pixel may include one or more grid structures GS. A pitch or distance between center points in the grid structures GS may be less than a wavelength of the light to be modulated. Alternatively or additionally, the spatial light modulator 30 may be provided so that a refractive index of the grid structure changes by an external electrical stimulation to control a resonance condition, and accordingly, a phase is modulated. A direction in which the light emitted from the spatial light modulator 30 travels may be determined according to a phase relationship between lights emitted from adjacent pixels.

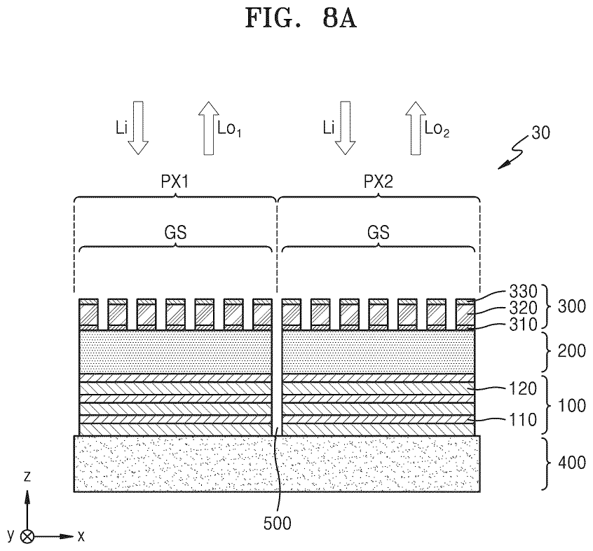

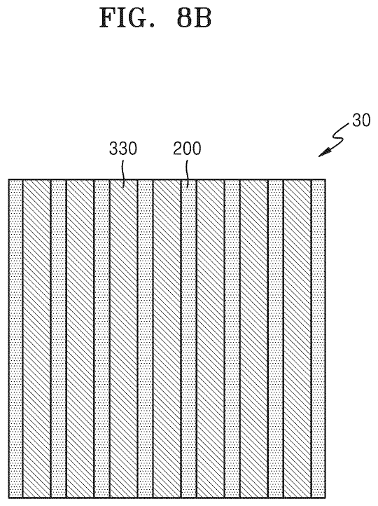

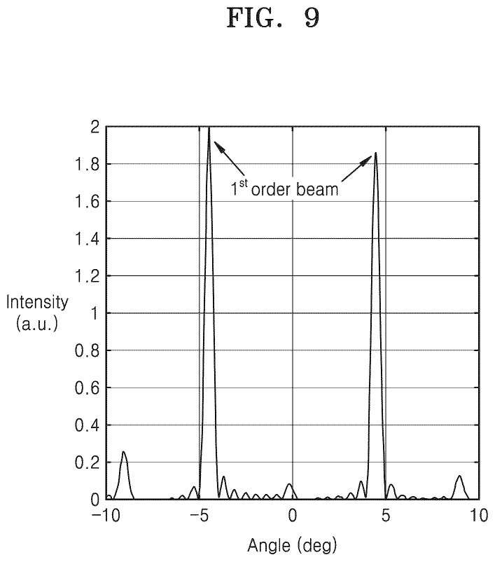

The spatial light modulator 30 may be driven according to a phase profile provided by the controller 40 to steer light in various directions. For example, the phase profile may be or may correspond to a binary electrical signal including an on signal or an off signal that is applied to each pixel of the spatial light modulator 30. The spatial light modulator 30 is described below with reference to FIGS. 8A, 8B, and 9.

As illustrated in FIG. 1, the spatial light modulator 30 may be provided to scan the scan area 1 in N resolution pixels in the scan direction (the y-axis direction). In some other examples, the spatial light modulator 30 may be provided to generate +n^{th}-order light and −n^{th}-order light (where n is a natural number of 1 or more) and may scan, for example, the first scan area 3 and the second scan area 5 of FIG. 2 respectively with the +n^{th}-order light and the −n^{th}-order light in time dimension in N resolution pixels. For example, the spatial light modulator 30 may scan the first scan area 3 in time dimension with +first-order light and scan the second scan area 5 in time dimension with −first-order light.

Alternatively or additionally, as illustrated in FIGS. 4A and 4B, when the transmission optical system 25 includes a steering element, such as the spatial light modulator 30, the light source 21 or the transmission optical system 25 may be provided to irradiate line light to the scan area 1 in a longitudinal direction (the x-axis direction).

In FIGS. 4A and 4B, the light source 21 may include one light source element 21a or a plurality of light source elements 21a arranged one-dimensionally in the longitudinal direction (the x-axis direction). By driving the plurality of light source elements 21a arranged one-dimensionally in the longitudinal direction (the x-axis direction) to turn on one or more sequentially or all together, light may be irradiated to the scan area in unit of at least one point or in line unit. As a result, the line light may be irradiated to the scan area for a certain period of time, or the line light may be irradiated at a single moment, and the scan area may be scanned in time division in a scan direction (the y-axis direction) according to the driving of the spatial light modulator 30.

Alternatively or additionally, the light source 21 may include a single light source element, for example, a single semiconductor laser, and the transmission optical system 25 may be provided to change the light emitted from one light source element to line light in the longitudinal direction (the x-axis direction). To this end, the transmission optical system 25 may include, for example, a collimating lens (e.g., 23a in FIG. 11) for collimating the light emitted from the light source 21, a cylinder lens (e.g., 25b in FIG. 11) for forming a line beam, and so on. In this case, as the spatial light modulator 30 is driven, a position at which the line light is irradiated to the scan area 1 is sequentially changed in the scan direction (the y-axis direction), and thereby, the scan area may be scanned.

Referring to FIGS. 3A, 3B, 4A, and 4B, in the 3D distance information acquisition device 10 according to some example embodiments, the receiver 50 may include the receiving optical system 70 and the photodetector. The receiving optical system 70 may be configured to have condensing power in the scan direction (the y-axis direction) greater than condensing power in the longitudinal direction (the x-axis direction), thereby condensing the light reflected from the scan area and incident thereon in a first range that is relatively less in a first direction, that is, a scan direction (the y-axis direction). The photodetector 60 may include a light receiving area to detect the condensed light in the first range. The light reflected from a target object in the scan area is collected by the receiving optical system 70 and received in one light receiving area of the photodetector 60 in the scan direction.

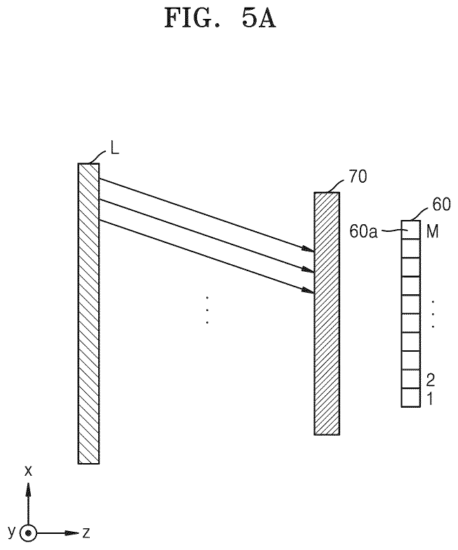

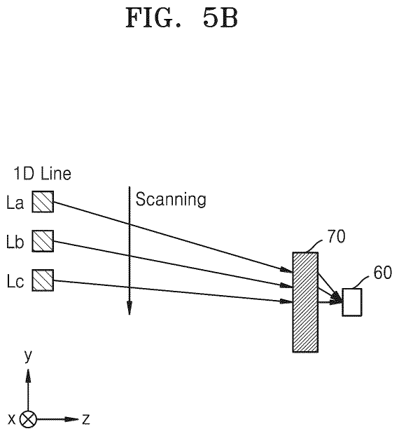

For example, the receiver 50 may detect light in time division in a ratio of N:1 for N resolution pixels (where N is an integer of 2 or more) in the scan direction of an object space in synchronization with scanning of the transmitter 20. To this end, as illustrated in FIGS. 5A and 5B, the receiving optical system 70 may be provided to condense the light reflected from a target object in a scan area and incident thereon in a first range that is relatively less in a first direction, that is, a scan direction (the y-axis direction), and the photodetector 60 may include a plurality of light receiving areas 60a arranged in a second direction, for example, a longitudinal direction (the x-axis direction), to detect light condensed in the first range. FIG. 5A illustrates a path of the light, which is reflected from the target object in the scan area and incident on the receiver 50, in a plane parallel to a second direction, that is, the longitudinal direction (the x-axis direction), and FIG. 5B illustrates a path of the light, which is reflected from the target object in the scan area and incident on the receiver 50, in a plane parallel to a first direction, that is, the scan direction (the y-axis direction). In FIG. 5A, L represents line light. In FIG. 5B, La, Lb, and Lc each represent line light that is scanned in time division.

As illustrated in FIGS. 5A and 5B, the scan area may be scanned in time division, and the light reflected from the scan area may be condensed by the receiving optical system 70 in the first range that is a relatively less in the first direction, for example, the scan direction (the y-axis direction), received in one light receiving area 60a in time division in N resolution pixels, and received in a plurality of light receiving areas in the second direction, for example, the longitudinal direction (the x-axis direction). To this end, the photodetector 60 may include M light receiving areas 60a arranged in a one-dimensional array in the longitudinal direction, and longitudinal information of the scan area may be received in M resolution pixels. In this case, the first range corresponds to a width of one light receiving area 60a in the first direction, for example, the scan direction (the y-axis direction), and the total width of the plurality of light receiving areas arranged in the second direction, that is, the longitudinal direction (the x-axis direction), is greater than the width of one light receiving area 60a in the first direction.

In addition, referring to FIGS. 3A and 4A, a delay time Δτ1 (delta-tau-1) until light is reflected from a near target object, such as target object 1, and returns to the photodetector 60 is shorter, and a delay time Δτ2 (delta-tau-2) until light is reflected from a distant object, such as target object 2 and returns to the photodetector 60 is longer.

When a time at which light reaching a near target object, such as target object 1, is emitted from the transmitter 20 is referred to as t1 and the time at which light reaching a distant target object, such as target object 2, is emitted is referred to as t2, a time at which the light emitted from the transmitter 20 at time t1 is reflected from the near target object 1 and detected by the photodetector 60 of the receiver 50 is t1+Δτ1, and a time at which the light emitted from the transmitter 20 at time t2 is reflected from the distant target object 2 and detected by the photodetector 60 is t2+Δτ2. Therefore, distance information to a target object or depth information to the target object and an environment may be obtained by using a delay time between the time when light is emitted and the time when the light returns.

The 3D distance information acquisition device 10 according to some example embodiments uses a time division method, for example, a method in which the light emitted from the light source 21 is used to scan individual points by varying the times t1, t2, and so on at which the light reaching each scan point is emitted. Therefore, the 3D distance information acquisition device 10 according to some example embodiments may detect the light reflected from a scan area 1 in time division in a ratio of N:1 in a scan direction, resulting in no need or in a reduced need for a photodetector array that requires or uses individual pixel detection in the scan direction, and thus, a form factor of the photodetector 60 and a peripheral circuit and memory corresponding thereto may be reduced, and computing power may also be greatly reduced.

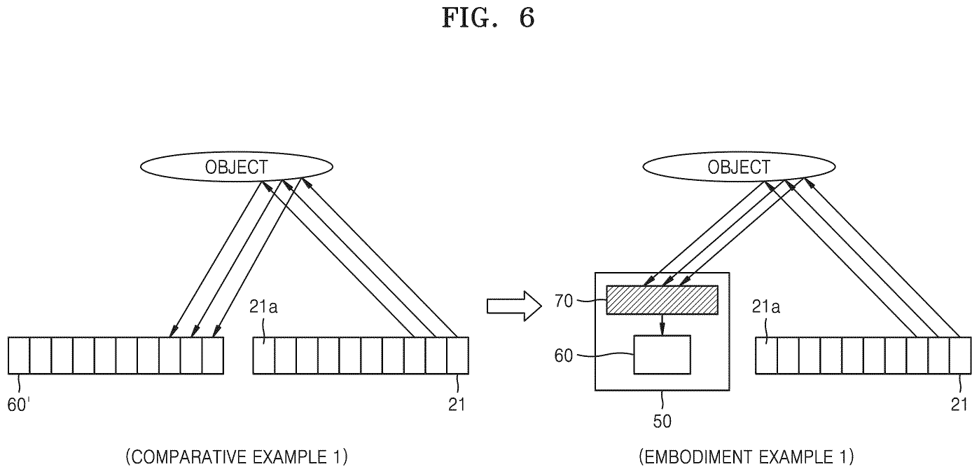

FIG. 6 illustrates a comparison between a 3D distance information acquisition device of Embodiment Example 1 and a 3D distance information acquisition device of Comparative Example 1, which have the same transmitter 20 but a difference in receivers 50 and 60′. In FIG. 6, the transmitter 20 of a 3D distance information acquisition device includes a light source 21 including a plurality of light source elements 20a and corresponds to the transmitter 20 of some example embodiments illustrated in FIGS. 3A and 3B.

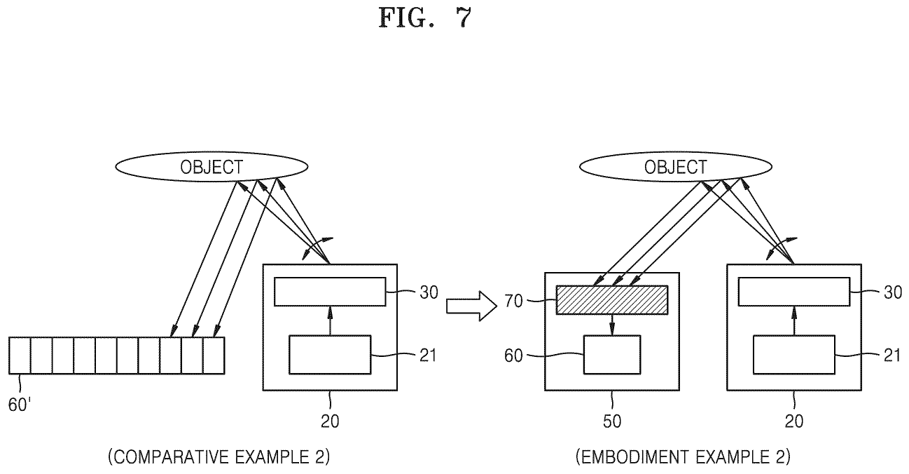

FIG. 7 illustrates a comparison between a 3D distance information acquisition device of implementation Embodiment Example 2 and a 3D distance information acquisition device of Comparative Example 2, which have the same transmitter 20 but a difference in receivers 50 and 60′. In FIG. 7, the transmitter 20 of a 3D distance information acquisition device may be provided to scan a scan area in time division in a scan direction (the y-axis direction) by steering light and corresponds to the transmitter 20 of some example embodiments illustrated in FIGS. 4A and 4B.

As illustrated in FIGS. 6 and 7, since the receiver 50 of Embodiment Examples 1 and 2 described above is provided to detect light in time division in a ratio of N:1 in N resolution pixels (where N is an integer of 2 or more) in a scan direction of an object space, individual pixel detection is required or used in the scan direction, and thus, a form factor of the photodetector 60 and a peripheral circuit and memory corresponding thereto may be reduced, and/or computing power may also be greatly reduced. On the other hand, the receiver 60′ of Comparative Examples 1 and 2 includes an array of a plurality of light receiving areas corresponding to the N resolution pixels, and accordingly, complex peripheral circuit and memory corresponding thereto are required or expected.

As may be seen in FIGS. 6 and 7, the 3D distance information acquisition device 10 according to some example embodiments may detect the light reflected from the scan area in time division in N:1 in a scan direction, for example, in one light receiving area and does not require a photodetector array for individual pixel detection in the scan direction, and thus, a form factor of the photodetector 60 and a peripheral circuit and memory corresponding thereto may be reduced, and computing power may also be greatly reduced.

FIG. 8A is a cross-sectional view illustrating a schematic example of a spatial light modulator 30 that may be applied to a 3D distance information acquisition device according to some example embodiments as a steering element. FIG. 8B is a plan view of one pixel PX1 or PX2 of the spatial light modulator 30 of FIG. 8A. FIG. 8A illustrates the first pixel PX1 and the second pixel PX2 as an example.

Referring to FIGS. 8A and 8B, a spatial light modulator 30 may include a first material layer 100, a cavity layer 200 on the first material layer 100, and a second material layer 300 on the cavity layer 200.

The spatial light modulator 30 may modulate a phase of incident light Li and may output the modulated phase. The spatial light modulator 30 may include a plurality of pixels to steer incident light by phase modulation. For example, the plurality of pixels may include the first pixel PX1 and the second pixel PX2. A pixel may represent the smallest unit independently driven in the spatial light modulator 30 or a basic unit capable of independently modulating a phase of light. Each pixel PX1 and PX2 may include one or more grid structures GS forming the second material layer 300. FIG. 8A illustrates a structure including two pixels PX1 and PX2. The spatial light modulator 30 may have a structure in which pixels are arranged one-dimensionally or two-dimensionally. A heat shield member may be provided between the plurality of pixels PX1 and PX2 to block heat transfer therebetween. FIG. 8A illustrates an example in which the heat shield member is implemented as a trench 500 up to a depth of the first material layer 100, but is not limited thereto. For example, the depth at which the trench 500 is formed may be changed. Additionally or alternatively, a heat shield member may be formed inside a stacked structure to reduce heat transfer between the plurality of pixels PX1 and PX2. For example, the heat shield member may be formed between a substrate 400 and the first material layer 100. However, example embodiments are not limited thereto, and the spatial light modulator 30 may not include a heat shield member.

In addition, although FIG. 8A illustrates that each pixel PX1 and PX2 includes seven grid structures GS, this is only an example, and some example embodiments is not limited thereto. A pitch between the grid structures GS may be smaller than a wavelength of the modulating light. A length of one side of each of the first and second pixels PX1 and PX2 may be, for example, 3 μm to 300 μm.

In this way, the spatial light modulator 30 may have a one-dimensional or two-dimensional array of a plurality of pixels to steer the incident light by phase modulation, and each pixel may include a stacked structure of the first material layer 310, the cavity layer 320, and the second material layer 330.

In addition, the spatial light modulator 30 may further include the substrate 400 supporting the first material layer 100. The substrate 400 may be formed of an insulating material. For example, the substrate 400 may be a transparent substrate (for example, a glass substrate) that transmits light therethrough or a semiconductor substrate (for example, a silicon substrate). In addition to this, various types of materials may be used as the substrate 400.

The first material layer 100 may be a distributed Bragg reflector. For example, the first material layer 100 may include a first layer 110 and a second layer 120 having different refractive indices. The first layer 110 and the second layer 120 may be alternately and repeatedly stacked. Due to a difference in refractive index between the first layer 110 and the second layer 120, light may be reflected from an interface of each layer and the reflected light may cause interference. The first layer 110 or the second layer 120 may include silicon (Si), silicon nitride (Si₃N₄), silicon oxide (SiO₂), titanium oxide (TiO₂), or so on. For example, the first layer 110 may be formed of silicon (Si), and the second layer 120 may be formed of silicon oxide (SiO₂). Light reflectance of the first material layer 100 may be designed by adjusting thicknesses and/or the number of stacking of the first layer 110 and the second layer 120.

The first material layer 100 may have a structure other than the distributed Bragg reflector and may include, for example, a metal material layer having one side formed of metal.

The cavity layer 200 is or corresponds to a region where incident light resonates and may be disposed between the first material layer 100 and the second material layer 300. The cavity layer 200 may include, for example, silicon oxide (SiO₂). A resonance wavelength may be determined according to a thickness of the cavity layer 200. The thicker the cavity layer 200 is, the longer the resonance wavelength of light is, and the thinner the thickness of the cavity layer 200 is, the shorter the resonance wavelength of light is.

The second material layer 300 may be designed to appropriately perform a reflection function of reflecting light of a specific wavelength and a phase modulation function of modulating a phase of the emitted light.

The second material layer 300 may include a plurality of grid structures GS arranged at preset intervals. A thickness, a width, and a pitch of the grid structure GS may be less than a wavelength of the light modulated by the spatial light modulator 30. Reflectance of the modulated light may be increased by adjusting the thickness, the width, the pitch, or so on of the grid structure GS. Reflectance of the second material layer 300 may be different from reflectance of the first material layer 100, and reflectance of the second material layer 300 may be less than reflectance of the first material layer 100.

The spatial light modulator 30 may be a reflective or transmissive spatial light modulator. FIG. 8A illustrates a case where the spatial light modulator 30 is a reflective spatial light modulator. The spatial light modulator 30 may also be provided as a transmissive spatial light modulator. Hereinafter, a case where the spatial light modulator 30 is a reflective spatial light modulator is described as an example.

The light Li that is incident on the spatial light modulator 30 may transmit through the second material layer 300, propagate to the cavity layer 200, and then be reflected by the first material layer 100, that is, the distributed Bragg reflector, after being trapped in the cavity layer 200 by the first material layer 100 and the second material layer 300 and resonating, the light Li may be emitted through the second material layer 300. The lights Lo₁ and Lo₂ respectively emitted from the first pixel PX1 and the second pixel PX2 may have a certain phase, and phases of the emitted lights Lo₁ and Lo₂ may be controlled by a refractive index of the second material layer 300. A direction in which light travels may be determined by a phase relationship between lights emitted from adjacent pixels. For example, when a phase of the emitted light Lo₁ of the first pixel PX1 is different from a phase of the emitted light Lo₂ of the second pixel PX2, a direction light may be determined by an interaction of the emitted lights Lo₁ and Lo₂.

In addition, the grid structure GS of the second material layer 300 in each of the first and second pixels PX1 and PX2 may include a first doped semiconductor layer 310, an intrinsic semiconductor layer 320, and a second doped semiconductor layer 330. For example, the first doped semiconductor layer 310 may be an n-type semiconductor layer including n-type dopants such as but not limited to arsenic and/or phosphorus, the second doped semiconductor layer 330 may be a p-type semiconductor layer including p-type dopants such as but not limited to boron, and the grid structure GS may be a PIN diode.

The first doped semiconductor layer 310 may be a silicon (Si) layer including a Group 5 element, for example, phosphorus (P) and/or arsenic (As) as an impurity. The concentration of an impurity included in the first doped semiconductor layer 310 may be 10¹⁵ to 10²¹ cm⁻³. The intrinsic semiconductor layer 320 may be a silicon (Si) layer that does not include an impurity. The second doped semiconductor layer 330 may be a silicon (Si) layer including a Group 3 element, for example, boron (B) as an impurity. The concentration of an impurity included in the second doped semiconductor layer 330 may be 10¹⁵ to 10²¹ cm⁻³.

When a voltage is applied between the first doped semiconductor layer 310 and the second doped semiconductor layer 330, a current may flow from the first doped semiconductor layer 310 to the second doped semiconductor layer 330, heat is generated in the grid structure GS by the current, and a refractive index of the grid structure GS may be changed due to the heat. When the refractive index of the grid structure GS changes, a phase of the light emitted from each of the first and second pixels PX1 and PX2 may change, and accordingly, a direction of the light emitted from the spatial light modulator 30 may be controlled by adjusting a voltage V applied to each of the first and second pixels PX1 and PX2.

The spatial light modulator 30 may include first and second electrodes (not illustrated) for applying a voltage to the grid structure GS. The first electrode may be in contact with one end of the first doped semiconductor layer 310, and the second electrode may be in contact with one end of the second doped semiconductor layer 330. The second electrode may be in contact with one end opposite to the end in contact with the first electrode. The first electrode may be on the cavity layer 200 and may be a common electrode that applies a common voltage to all pixels included in the spatial light modulator 30. The second electrode may be a pixel electrode designed to apply a different voltage to each pixel.

Here, although the grid structure GS of the PIN structure is described, example embodiments are not limited thereto. The grid structure GS may be a NIN structure or a PIP structure. For example, the first doped semiconductor layer 310 and the second doped semiconductor layer 330 may be an n-type semiconductor layer or a p-type semiconductor layer.

The grid structure GS of the spatial light modulator 30 according to some example embodiments may be based on silicon. A refractive index of silicon is proportional to temperature. The greater the temperature change of silicon, the greater the change in refractive index of silicon. Because the change in refractive index of silicon is directly proportional to a change in temperature of silicon, the change in refractive index may be easily adjusted by adjusting the change in temperature. Therefore, a refractive index of the grid structure GS may be easily adjusted by controlling an electrical signal applied to silicon.

The spatial light modulator 30 according to some example embodiments may be provided to modulate a phase by controlling a resonance condition by changing a refractive index of the grid structure GS due to an external electrical stimulation and may be driven according to a phase profile provided by the controller 40 to steer light in various directions. For example, the above-described phase profile may be a binary electrical signal in which an on signal or an off signal is applied to each pixel.

When a light wave is incident on a resonance structure capable of storing light waves, such as the spatial light modulator 30 described with reference to FIGS. 8A and 8B, a phase reflected or transmitted due to the resonance changes rapidly. When a voltage is applied to the resonance structure, a refractive index of a material forming a resonator changes, and as a result, a reflected or transmitted phase of light waves of a given wavelength changes.

For example, the spatial light modulator 30 may increase a temperature difference between a driving pixel and a non-driving pixel, for example, the first pixel PX1 and the second pixel PX2 due to the presence of a heat shield member, for example, the trench 500, thereby reducing the intensity of zero-order light (zero-order diffracted light). In the spatial light modulator 30, for example, one of the first pixel PX1 and the second pixel PX2 may be the driving pixel, and the other may be the non-driving pixel. For example, the spatial light modulator 30 may be driven such that +n^{th}-order light and −n^{th}-order light, for example, +first-order light and −first-order light is dominant, as illustrated in FIG. 9. In FIG. 9, one of two first-order beams may be +first-order light and the other may be −first-order light. As illustrated in FIG. 2, by using +first-order light and −first-order light formed by the spatial light modulator 30, the 3D distance information acquisition device 10 according to some example embodiments may divide the range of field of view into first scan area 3 and the second scan area 5 and simultaneously scan each of the first scan area 3 and the second scan area 5 in time division in N resolution pixels in a scan direction.

In some examples, the spatial light modulator 30 may not include a heat shield member, or a temperature difference between driving pixels and non-driving pixels may not be great. In this case, the spatial light modulator 30 may be driven such that zero-order light (zero-order diffracted light) is extremely dominant. In this case, as illustrated in FIG. 1, the 3D distance information acquisition device according to various example embodiments may scan the scan area 1 in the range of field of view in time division in N resolution pixels in the scan direction. Hereinafter, a case, in which, as shown in FIG. 2, the range of field of view is divided into the first scan area 3 and the second scan area 5 by +n^{th}-order light and −n^{th}-order light, for example, +first-order light and −first-order light, formed by the spatial light modulator 30, and the first scan area 3 and the second scan area 5 are simultaneously scanned in time division in N resolution pixels in the scan direction, is described as an example.

In this way, when phase modulation elements are made into a one-dimensional or two-dimensional array and different voltages are applied to each unit pixel constituting each array to have different phases, an angle at which light wave incident from the outside is reflected or transmitted may change in a certain direction according to an input voltage distribution, and beam steering may be achieved. Unlike using a mechanically rotating mirror, MEMS, or so on, the beam steering method using the spatial light modulator 30 does not require a mechanical movement and may allow solid-state driving, thereby being resistant to external shock or vibration.

Therefore, the 3D distance information acquisition device 10 according to some example embodiments performs beam steering in a non-mechanical manner by using the spatial light modulator 30 capable of solid phase driving, thereby being resistant to external shock or vibration.

FIGS. 10 and 11 illustrate beam steering performed by the transmitter 20 of the 3D distance information acquisition device 10 according to embodiments. FIG. 10 illustrates an example in which the spatial light modulator 30 has a two-dimensional array of a plurality of pixels, and a diverging lens 25a is a concave lens to expand a beam steering range. Instead of this, a diverging lens 25b made of a concave cylinder lens may also be applied to expand the beam steering range as illustrated in FIG. 11. When the concave cylinder lens is applied as the diverging lens 25b, the light emitted from the transmitter 20 may be formed as line light.

Referring to FIGS. 10 and 11, the pulse light emitted from a light source 21 may be collimated by a collimating lens 23a constituting a light source optical system 23 and be incident on the spatial light modulator 30. The pulse light incident on the spatial light modulator 30 may be steered by the spatial light modulator 30. In FIGS. 10 and 11, SBa, SBb, SBc, and SBd represent, for example, beams steered by the spatial light modulator 30. For example, first steering beams SBa and SBb may be formed by +first-order light, and second steering beams SBc and SBd may be formed by −first-order light.

Since the light emitted from the light source 21 is pulse light, and the spatial light modulator 30 modulates a phase of the incident pulse light to adjust a direction of the light in a desired direction, the first steering beams SBa and SBb and the second steering beams SBc and SBd may be generated sequentially in time, for example, clockwise and counterclockwise, respectively, by the spatial light modulator 30 and may also be generated sequentially in time in a reverse direction thereof. For example, the first steering beam SBa and the second steering beam SBd may be emitted simultaneously at emission time ta, the first steering beam SBb and the second steering beam SBc may be emitted simultaneously at emission time tb, and the emission time ta may be different from the emission time tb. Also, as illustrated in FIGS. 10 and 11, a steering range of beams SBa, SBb, SBc, and SBd steered by the spatial light modulator 30 may be expanded by the diverging lenses 25a and 25b constituting a light output optical system 25. As illustrated in FIG. 11, when the transmitter 20 includes a cylinder lens as the diverging lens 25b, line-type scan light may be irradiated to a scan area.

The 3D distance information acquisition device 10 according to some example embodiments as described above may acquire 3D distance information or depth information by steering the light emitted from the light source 21 one-dimensionally or two-dimensionally. For example, in order to make phase modulation elements of the spatial light modulator 30 in a one-dimensional or two-dimensional array, different voltages are applied to each unit pixel constituting each array of the spatial light modulator 30 to have different phases, and accordingly, the light emitted from the light source 21 may be steered one-dimensionally. Also, for example, in order to make phase modulation elements of the spatial light modulator 30 in a two-dimensional array, different voltages may be applied to each unit pixel constituting each array of the spatial light modulator 30 to have different phases, and accordingly, the light emitted from the light source 21 may be steered two-dimensionally.

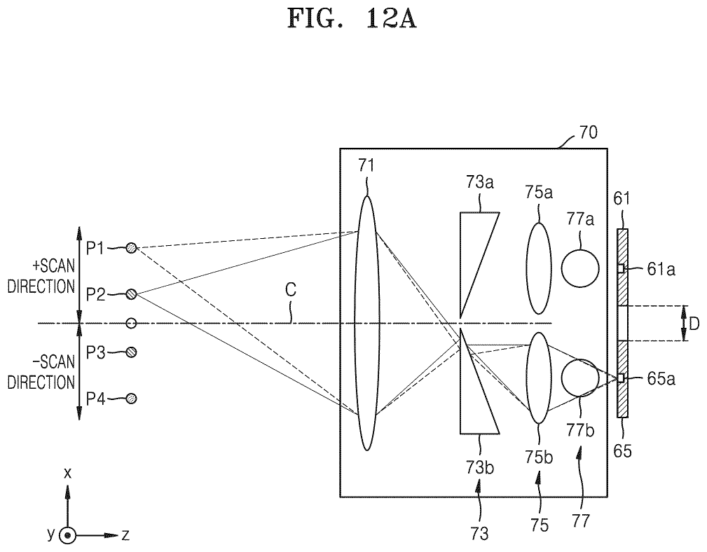

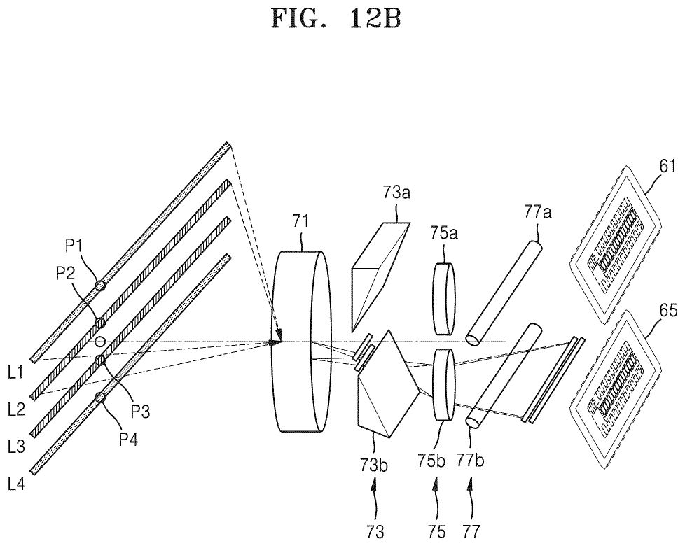

FIG. 12A illustrates an example of an optical configuration of a receiver 50 of a 3D distance information acquisition device 10 according to some example embodiments. FIG. 12B illustrates a perspective view of the optical configuration of FIG. 12A.

Referring to FIGS. 12A and 12B, the receiver 50 may include a receiving optical system 70 and a plurality of photodetectors, for example, first and second photodetectors 61 and 65. The first photodetector 61 may include a plurality of light receiving areas 61a arranged one-dimensionally in a longitudinal direction and the second photodetector 65 may include a plurality of light receiving areas 65a arranged one-dimensionally in the longitudinal direction. The first photodetector 61 and the second photodetector 65 may be separated from each other by a distance D. The distance D between the first photodetector 61 and the second photodetector 65 may be determined according to the design of the receiving optical system 70.

The receiving optical system 70 may be configured such that condensing power in a first direction, that is, a scan direction (the x-axis direction) is greater than condensing power in a second direction, that is, the longitudinal direction (the y-axis direction). For example, the receiving optical system 70 may be configured to have anisotropic condensing power. To this end, the receiving optical system 70 may include a first lens 71 on an incident side, a prism member 73 including first and second prism members 73a and 73b, and a condensing lens 77 including first and second condensing lenses 77a and 77b. The receiving optical system 70 may further include a lens 75 between the prism member 73 and the condensing lens 77. That is, the receiving optical system 70 may include a second lens 75a between the first prism member 73a and the first condensing lens 77a, and a third lens 75b between the second prism member 73b and the second condensing lens 77b. The first lens 71 is a lens having a large diameter and receives and condenses the light reflected from the scan area 1. The first and second prism members 73a and 73b may be disposed symmetrically to each other with respect to a longitudinal (the y-axis direction) plane including a central axis C of the first lens 71, and may be disposed such that portions farther from each other are thicker.

The condensing lens 77 may be provided such that a refractive power in the first direction, for example, the scan direction (the y-axis direction) is greater than a refractive power in the second direction, that is, the longitudinal direction (the x-axis direction), and have an anisotropic condensing power. For example, the condensing lens 77 may be provided to have different focal lengths such that a focal length in the first direction, that is, the scan direction (the y-axis direction) is much smaller than a focal length in the second direction, that is, the longitudinal direction (the x-axis direction). The first condensing lens 77a may be provided so that a refractive power in the first direction, for example, the scan direction (the y-axis direction) is greater than a refractive power in the second direction, that is, the longitudinal direction (the x-axis direction), and thus may have anisotropic condensing power, and condense the light incident through the first prism member 73a in the scan direction. The second condensing lens 77b may be provided so that a refractive power in the first direction, for example, the scan direction (the y-axis direction) is greater than a refractive power in the second direction, that is, the longitudinal direction (the x-axis direction), and thus may have anisotropic condensing power, and may condense the light incident through the second prism member 73b in the scan direction.

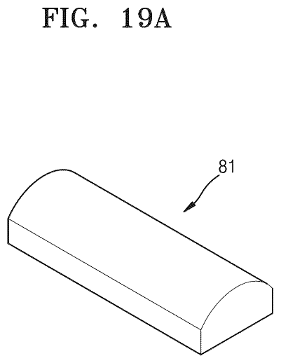

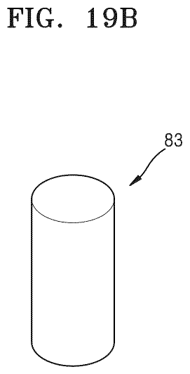

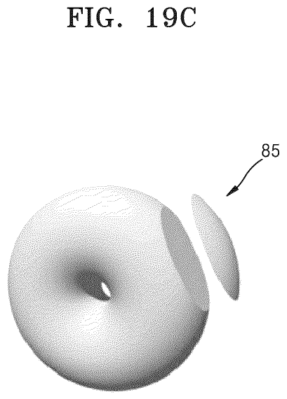

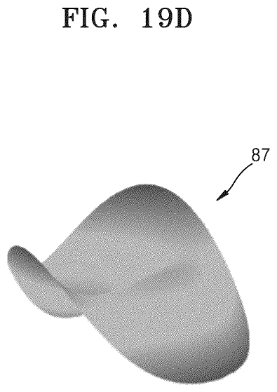

By the first and second condensing lenses 77a and 77b, light may be received in one light receiving area 61a and 65a of the first and second photodetectors 61 and 65 in the scan direction and may be received into M resolution pixels by M light receiving areas 61a and 65a arranged in a one-dimensional array in the longitudinal direction. The first condensing lens 77a and the second condensing lens 77b may include one of a semi-cylindrical lens (81 in FIG. 19A), a rod-shaped lens (83 in FIG. 19B) with a round cross-section, a toric lens (85 in FIG. 19C), and a freeform lens (87 in FIG. 19D) to have anisotropic refractive power. FIGS. 12A and 12B illustrate an example in which the first condensing lens 77a and the second condensing lens 77b are rod-type lenses. The second and third lenses 75a and 75b may be single-focus lenses with a very short focal length. Here, the first lens 71 may be composed of a group including a plurality of lenses. Each of the first condensing lens 77a and the second condensing lens 77b may be composed of a group including a plurality of lenses and/or may be composed of a combination of a plurality types of lenses. Each of the second lens 75a and the third lens 75b may be composed of a group including a plurality of lenses.

As illustrated in FIGS. 12A and 12B, the light reflected from a +scan area above a plane parallel to the longitudinal direction (the x-axis direction) with respect to an optical axis C of the first lens 71 and entering the first lens 71 may be condensed by the first lens 71 and be incident on the second prism member 73b located below. The second prism member 73b may serve to spread two real images coming from different points 1 (P1) and 2 (P2) in the scan direction in the +scan area so that the two real images do not overlap each other. By the second condensing lens 77b or a combination of the third lens 75b and the second condensing lens 77b, the two real images coming from the point 1 (P1) and the point 2 (P2) are imaged at substantially the same position on the second photodetector 65. That is, the light coming from the point 1 (P1) and the point 2 (P2) may be received to the same light receiving area 65a of the second photodetector 65 by the receiving optical system 70.

The light reflected from a −scan area below the plane parallel to the longitudinal direction (the x-axis direction) with respect to the optical axis C and entering the first lens 71, may be condensed by the first lens 71 and be incident on the first prism member 73a located above. The first prism member 73a may serve to spread two real images coming from a point 3 (P3) and a point 4 (P4) in the scan direction in the −scan area so that the two real images do not overlap each other. By the first condensing lens 77a or a combination of the second lens 75a and the first condensing lens 77a, the two real images coming from the point 3 (P3) and the point 4 (P4) are imaged at substantially the same position on the first photodetector 65. That is, the light coming from the point 3 (P3) and the point 4 (P4) may be received to the same light receiving area 61a of the first photodetector 61 by the receiving optical system 70.

As illustrated in FIG. 2, when performing scanning by dividing a range of field of view into the first and second scan areas 3 and 5, the +scan area corresponds to, for example, the first scan area 3, and the −scan area corresponds to, for example, the second scan area 5. Also, when scanning the +scan area and −scan area by, for example, +first-order light and −first-order light formed by the spatial light modulator 30, the point 1 (P1) and the point 4 (P4) may be simultaneously scanned, and the point 2 (P2) and the point 3 (P3) may be simultaneously scanned. As illustrated in FIG. 1, when scanning the entire range of field of view as the scan area 1, for example, the point 1 (P1) and the point 2 (P2) located in the +scan area may be sequentially scanned, and then the point 3 (P3) and the point 4 (P4) located in the −scan area may be sequentially scanned, and the scanning may also be performed in reverse.

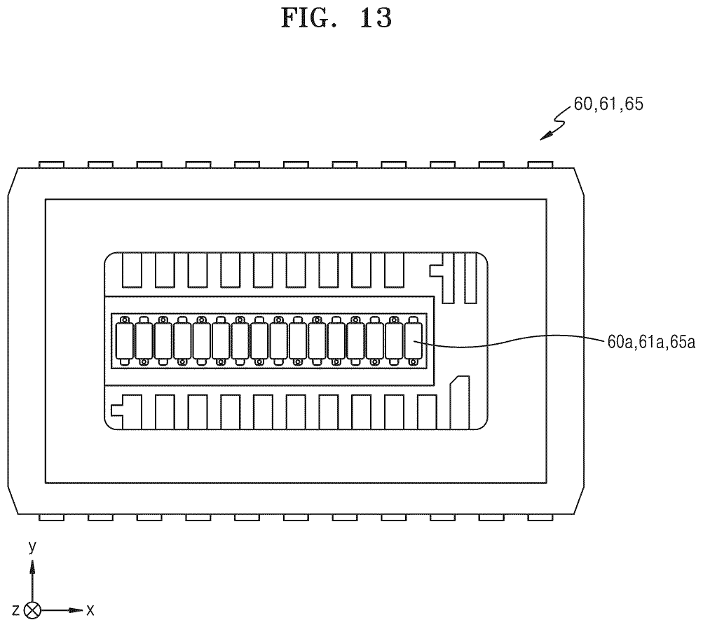

FIG. 13 illustrates an example of a photodetector 60, 61, or 65 that may be applied to the 3D distance information acquisition device according to the various embodiments described above.

Referring to FIG. 13, the photodetector 60, 61, or 65 may include M light receiving areas 60a, 61a, or 65a arranged in a one-dimensional array in the longitudinal direction (the x-axis direction), and accordingly, longitudinal information of a scan area may be acquired in M resolution pixels.

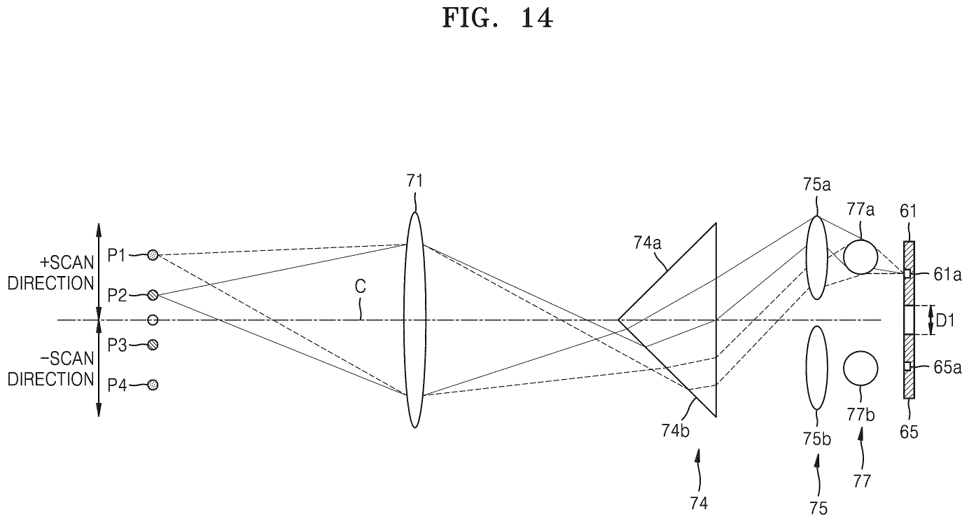

FIG. 14 illustrates another example of an optical configuration of a receiver 50 of the 3D distance information acquisition device according to some example embodiments. Compared to the receiving optical system of FIGS. 12A and 12B, a receiving optical system of FIG. 14 may include one prism member 74 instead of the first prism member 73a and the second prism member 73b. As a result, as may be seen from an optical path illustrated in FIG. 14, the light entering a receiving optical system from a point 1 (P1) and a point 2 (P2) of a +scan area is received to the first photodetector 61, and the light entering a receiving optical system from a point 3 (P3) and a point 4 (P4) of a −scan area is received to the second photodetector 65. The receiving optical system may be provided such that the first photodetector 61 and the second photodetector 65 may be separated from each other by a distance D1.

Referring to FIG. 14, the prism member 74 is disposed to have a large thickness on a central axis C of the first lens 71 and have a first surface 74a and a second surface 74b inclined to each other on a side on which the light passing through the first lens 71 is incident.

By the prism member 74, the light entering the first lens 71 from the point 1 (P1) and the point 2 (P2) of the +scan area located above with respect to the plane parallel to a longitudinal direction (the x-axis direction) is refracted and condensed by the first lens 71 and is incident on the second surface 74b of the prism member 74 located below. The light refracted at the second surface 74b of the prism member 74 is directed again to the second lens 75a and the first condensing lens 77a located above and is received to the same light receiving area 61a of the photodetector 61 by the first condensing lens 77a. Also, the light entering the first lens 71 from the point 3 (P3) and the point 4 (P4) of the −scan area below with respect to the plane parallel to the longitudinal direction (the x-axis direction) is refracted and condensed by the first lens 71 and is incident on the first surface 74a of the prism member 74 located above. The light refracted at the first surface 74a of the prism member 74 is directed again to the third lens 75b and the second condensing lens 77b located below and is received to the same light receiving area 65a of the second photodetector 65 by the second condensing lens 77b.

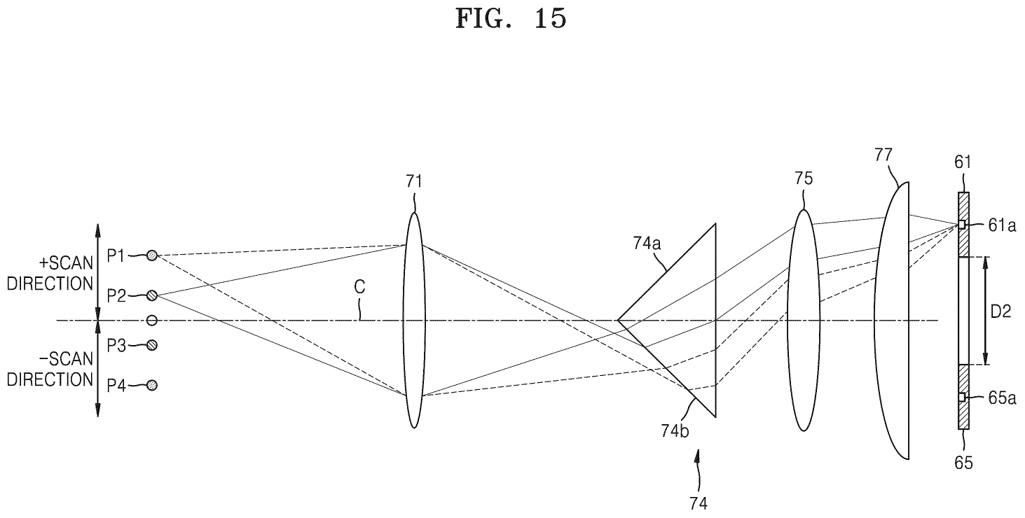

FIG. 15 illustrates another example of the optical configuration of the receiver 50 of the 3D distance information acquisition device 10 according to some example embodiments. Compared to the receiving optical systems of FIGS. 12A, 12B, and 14, a receiving optical system of FIG. 15 may include one prism member 74, and be configured so that the light coming from a point 1 (P1) and a point 2 (P2) of a +scan area and the light coming from a point 3 (P3) and a point 4 (P4) of a −scan area utilize different areas of a single lens. That is, a condensing lens 77 may be provided instead of the first condensing lens 77a and the second condensing lens 77b. Also, instead of the second lens 75a and the third lens 75b, a lens 75 may be provided between the prism member 74 and the condensing lens 77. In this case, the condensing lens 77 may include at least one of a rod-shaped lens with a round cross-section, a semi-cylindrical lens, a toric lens, and a freeform lens to have anisotropic refractive power. Here, the first lens 71 may be composed of a group including a plurality of lenses. The condensing lens 77 may be composed of a group including a plurality of lenses, or may be composed of a combination of a plurality of types of lenses. The condensing lens 77 may be provided such that the first photodetector 61 and the second photodetector 65 may be separated from each other by a distance D2. FIG. 15 illustrates an example in which a semi-cylindrical lens is used as the condensing lens 77. In addition, the lens 75 may be composed of a group including a plurality of lenses.

Referring to FIG. 15, the light entering the first lens 71 from the point 1 (P1) and the point 2 (P2) of the +scan area above with respect to the plane parallel to a longitudinal direction (the x-axis direction), is refracted and condensed by the first lens 71 and is incident on a second surface 74b of the prism member 74 located below. The light refracted at the second surface 74b of the prism member 74 is directed upward again and is condensed by upper areas of the lens 75 and the condensing lens 77 and is received to the same light receiving area 61a of the first photodetector 61. Also, the light entering the first lens 71 from the point 3 (P3) and the point 4 (P4) of the −scan area below with respect to the plane parallel to the longitudinal direction (the x-axis direction), is refracted and condensed by the first lens 71 and is incident on a first surface 74a of the prism member 74 located above. The light refracted at the first surface 74a of the prism member 74 is directed downward again and is condensed by lower areas of the lens 75 and the condensing lens 77 and is received to the same light receiving area 65a of the second photodetector 65.

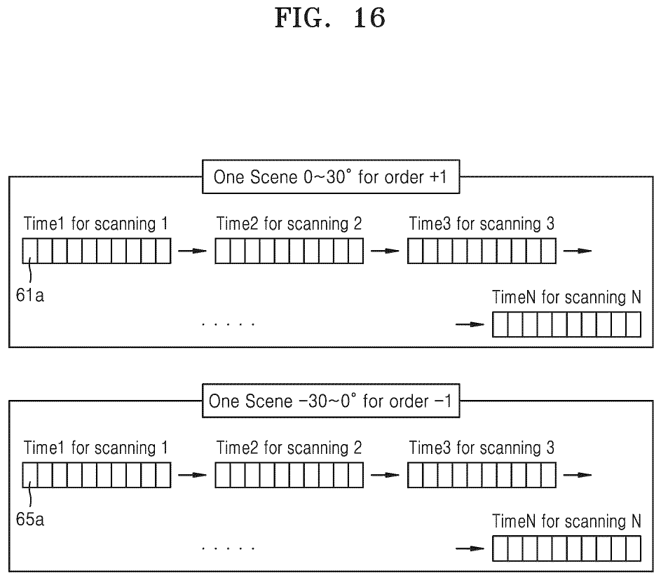

FIG. 16 illustrates schematic time-division signal processing of two pieces of line scanning. FIG. 16 illustrates time-division signal processing when time-division line scanning is performed in a range of 30° with +first-order light and −first-order light formed by the spatial light modulator 30. When time-division line scanning is performed in a range of 0 to 30° with +first-order light and in a range of −30 to 0° with −first-order light for one scene, the time-division line scanning may be performed simultaneously with the +first-order light and −first-order light.

Therefore, the +first-order light scanned in N resolution pixels (where N is an integer of 2 or more) in a scan direction of an object space may be received to one light receiving area 61a in time division in a ratio of N:1, as illustrated in the time-division signal processing in an upper portion of FIG. 16, and at the same time, the −first-order light scanned in N resolution pixels may be received to one light receiving area 65a in time division in a ratio of N:1, as illustrated in the time-division signal processing in a lower portion of FIG. 16. That is, the scanned +first-order light is received to one light receiving area 61a in time division in N resolution pixels, and the scanned −first-order light is received to one light receiving area 65a in time division in N resolution pixels. Also, longitudinal information of a scan area is received in M resolution pixels.

Although FIGS. 12A, 12B, 14, 15, and 16 illustrate an example in which the light scanning the +scan area is received to one of the first photodetector 61 and the second photodetector 65 in time division in a ratio of N:1 and the light scanning the −scan area is received to the other of the first photodetector 61 and the second photodetector 65 in time division in a ratio of N:1, the disclosure is not limited thereto. For example, the receiver 50 may be provided such that one photodetector 60 receive the light scanning the +scan area and the light scanning the −scan area. In this case, the prism members 74, 74a, and 74b may be omitted, and the photodetector 60 may be arranged such that the light receiving area 60a is located on an optical axis of the first lens 71, and time-division signal processing may correspond to the time-division signal processing in the upper or lower portion of FIG. 16.

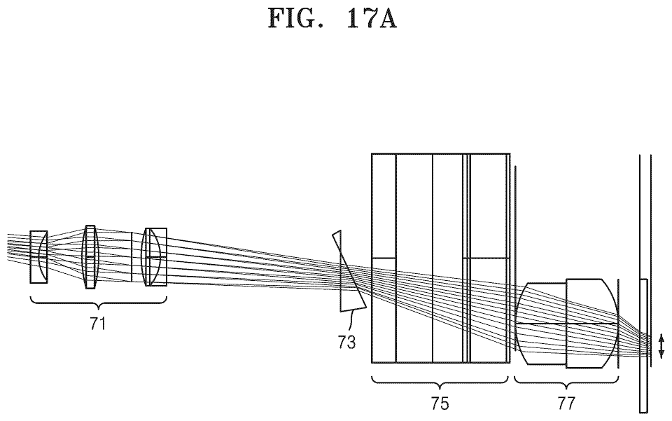

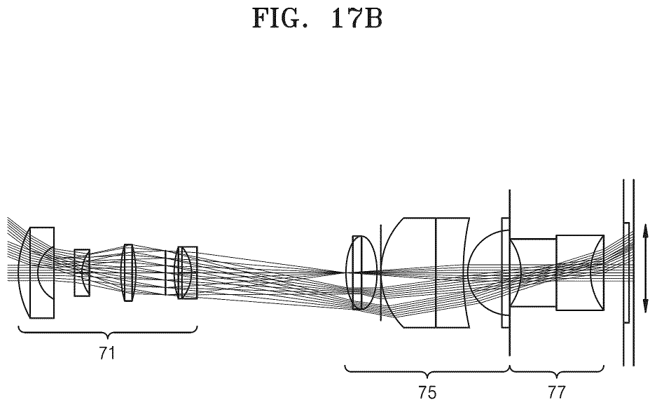

FIGS. 17A and 17B are respectively a side view and a plan view illustrating a design example of a receiving optical system according to some example embodiments.

As illustrated in FIGS. 17A and 17B, a first lens 71 may be composed of a group including a plurality of lenses. A lens 75 between a prism member 73 and a condensing lens 77 may be a single-focus lens and may be composed of a group including a plurality of lenses. Also, the condensing lens 77 may be composed of a group including a plurality of lenses. The lens 75 may include a second lens 75a and a third lens 75b, as illustrated in FIGS. 12A, 12B, and 14. Also, the condensing lens 77 may include a first condensing lens 77a and a second condensing lens 77b, as illustrated in FIGS. 12A, 12B, and 14. In the plan view of FIG. 17B, the prism member 73 is omitted because the prism member 73 does not affect an optical path.

As may be seen from FIGS. 17A and 17B, the light coming from a plurality of points in a scan direction may be focused within a certain range corresponding to one light receiving area in a receiving optical system. Therefore, when an object space is scanned in time division in a plurality of resolution pixels N, the light entering the receiving optical system may be received to one light receiving area in time division in a ratio of N:1.

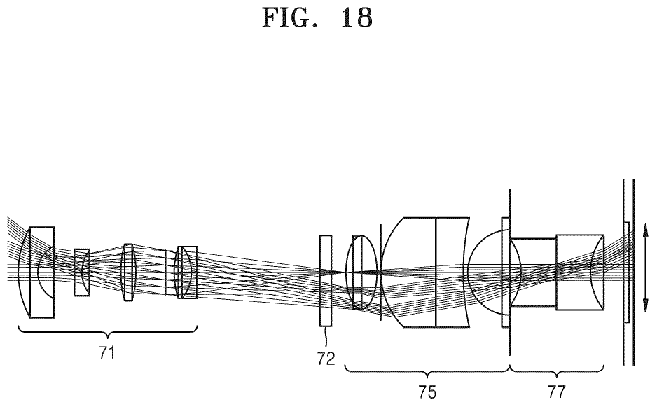

Alternatively or additionally, as illustrated in FIG. 18, the receiving optical system may further include a band-pass filter 72 that passes only a light wavelength band of a transmitter 20. For example, the band pass filter 72 may be disposed at a position in which an angle of a chief ray is small on an optical path within the receiving optical system. FIG. 18 illustrates an example in which the band pass filter 72 is disposed between the first lens 71 and the lens 75. The band pass filter 72 may block the influence of ambient light.

FIGS. 19A to 19D illustrate various lenses that may be used as condensing lenses 77, 77a, and 77b of the receiving optical system 70 of the 3D distance information acquisition device according to some example embodiments. A semi-cylinder lens 81 illustrated in FIG. 19A may be used as the condensing lenses 77, 77a, and 77b. The semi-cylinder lens 81 is a lens having a curvature in only one direction. A rod-type lens 83 illustrated in FIG. 19B may be used as the condensing lenses 77, 77a, and 77b. The rod-type lens 83 has a rod shape and has lens power in only one direction. A toric lens 85 illustrated in FIG. 19C may be used as the condensing lens 77, 77a, and 77b. As illustrated in FIG. 19C, the toric lens 85 may have a shape of a torus cap and operate as if a spherical lens and a cylindrical lens are combined with each other. The toric lens 85 may have different curvatures in the x-axis direction and the y-axis direction. A freeform lens 87 illustrated in FIG. 19D may be used as the condensing lens 77, 77a, and 77b. The freeform lens 87 may be designed such that a refractive power in a scan direction (the y-axis direction) is greater than a refractive power in a longitudinal direction (the x-axis direction).

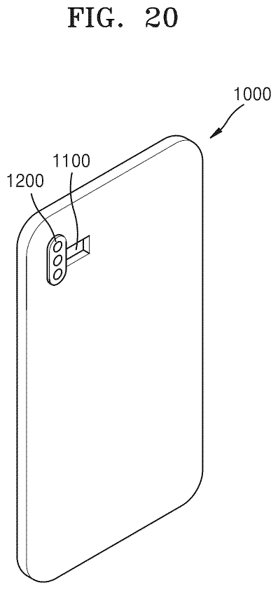

FIG. 20 is a conceptual diagram illustrating a case where a 3D distance information acquisition device according to some example embodiments is applied to a mobile device. FIG. 20 illustrates an example in which a plurality of cameras 1200 and a 3D distance information acquisition device 1100 are applied to the rear of a mobile device 1000. The 3D distance information acquisition device 1100 may be mounted on the mobile device 1000 and serve as a mobile LiDAR sensor. Also, the 3D distance information acquisition device 1100 may serve as a mobile ultra-small depth camera that acquires a 3D image by being combined with a plurality of cameras 1200. The 3D distance information acquisition device 1100 may be used as the 3D distance information acquisition device 10 according to the various embodiments described above. The 3D distance information acquisition device 1100 may acquire distance information or depth information of a subject to be photographed with the camera 1200, which may be used to adjust a focus of a camera or may be applied to the captured video or image, and accordingly, 3D information of the subject.

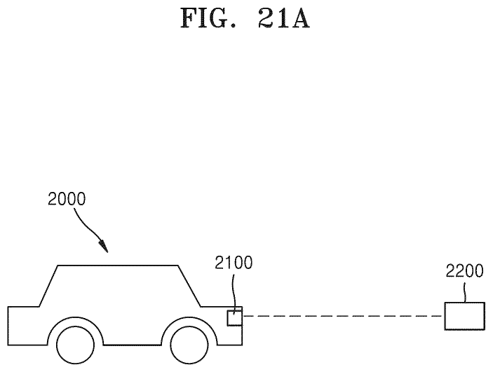

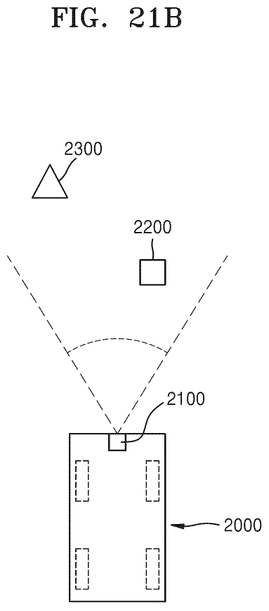

FIGS. 21A and 21B are conceptual diagrams illustrating a case where a 3D distance information acquisition device according to some example embodiments is applied to a vehicle. FIG. 21A is a side view, and FIG. 21B is a top view.

Referring to FIG. 21A, the 3D distance information acquisition device 10 according to the various embodiments described above may be implemented as a LIDAR device 2100 to be applied to a vehicle 2000 and may acquire information on an object 2200. The vehicle 2000 may be a car with an autonomous driving function. A thing or person, that is, the object 2200 in a direction in which the vehicle 2000 travels may be detected by using the LIDAR device 2100. In some cases, a distance to the object 2200 may be measured by using information, such as a time difference between a transmission signal and a detection signal. Also, as illustrated in FIG. 21B, information on the near object 2200 and a distant object 2300 in a scan range may be acquired.

According to a 3D distance information acquisition device of some example embodiments and an electronic device including the 3D distance information acquisition device, a receiver may be configured to detect in a ratio of N:1 for N resolution pixels in a scan direction of an object space, and thus, a form factor of a photodetector and a peripheral circuit and memory corresponding thereto may be reduced, and computing power may also be greatly reduced.

Some example embodiments described above are merely examples, and various modifications and other equivalent embodiments may be made by those skilled in the art. Therefore, the true scope of technical protection according to some example embodiments should be determined by the technical idea of the disclosure described in the claims below.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Any or all of the elements described with reference to various figures may communicate with any or all other elements described with reference to the various figures For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

It should be understood that various example embodiments described herein should be considered in a descriptive sense only and not for purposes of limitation. Descriptions of features or aspects within each embodiment should typically be considered as available for other similar features or aspects in other embodiments. While one or more example embodiments have been described with reference to the figures, it will be understood by those of ordinary skill in the art that various changes in form and details may be made therein without departing from the spirit and scope as defined by the following claims.

What is claimed is:

1. A three-dimensional distance information acquisition device comprising:
a transmitter configured to irradiate light to a scan area, scan the scan area in time division in a first direction, and irradiate light in at least one of a point unit or a line unit in a second direction orthogonal to the first direction;
a receiver including a receiving optical system configured to have condensing power in the first direction greater than condensing power in the second direction, the receiving optical system configured to condense light reflected from the scan area and incident within a first range in the first direction, and the receiver including a photodetector having a light receiving area configured to detect the light condensed within the first range, and the photodetector configured to collect the light reflected from the scan area by using the receiving optical system and receive the light in at least one light receiving area in the first direction; and
a controller configured to acquire three-dimensional distance information of the scan area from a detection signal of the photodetector by controlling the transmitter and the receiver.

2. The three-dimensional distance information acquisition device of claim 1, wherein
the photodetector includes a plurality of light receiving areas arranged in the second direction,
the receiving optical system is configured to collect light reflected from the scan area, to receive at one light receiving area in the first direction, and to receive across a plurality of light receiving areas in the second direction,
the first range corresponds to a width of the one light receiving area in the first direction, and
a total width of the plurality of light receiving areas arranged in the second direction is greater than the width of the one light receiving area in the first direction.

3. The three-dimensional distance information acquisition device of claim 2, wherein the photodetector includes:
a first photodetector configured to receive light reflected from a first scan area corresponding to a positive first position in the first direction and condensed by the receiving optical system; and
a second photodetector that receives light reflected from a second scan area corresponding to a negative first position in the first direction and condensed by the receiving optical system,
each of the first photodetector and the second photodetector has a plurality of light receiving areas arranged in the second direction,
the receiving optical system is configured to collect the light reflected from the first scan area, to receive to one light receiving area of the first photodetector in the first direction and to receive across a plurality of light receiving areas of the first photodetector in the second direction, and
the receiving optical system is configured to collect the light reflected from the second scan area, to receive to one light receiving area of the second photodetector in the first direction and to receive across a plurality of light receiving areas of the second photodetector in the second direction.

4. The three-dimensional distance information acquisition device of claim 3, wherein the receiving optical system includes:
a first lens on an incident side and configured to receive and condense light reflected from the first and second scan areas;
first and second prism members arranged symmetrical to each other with respect to a central axis of the first lens and thick at portions farther from each other;
a first condensing lens provided such that a refractive power in the first direction is greater than a refractive power in the second direction to focus light incident through the first prism member, in the first direction; and
a second condensing lens provided such that a refractive power in the first direction is greater than a refractive power in the second direction to focus light incident through the second prism member, in the first direction.

5. The three-dimensional distance information acquisition device of claim 4, wherein the receiving optical system further includes a second lens between the first prism member and the first condensing lens, and a third lens between the second prism member and the second condensing lens.

6. The three-dimensional distance information acquisition device of claim 4, wherein each of the first condensing lens and the second condensing lens independently includes at least one of a rod-shaped lens with a round cross-section, a semi-cylindrical lens, a toric lens, and a freeform lens.

7. The three-dimensional distance information acquisition device of claim 3, wherein the receiving optical system includes:
a first lens on an incident side and configured to receive and condense the light reflected from the first and second scan areas;
a prism member disposed to have a greater thickness on a central axis of the first lens and have a first surface and a second surface inclined to each other on a side on which light passing through the first lens is incident;
a first condensing lens provided such that a refractive power in the first direction is greater than a refractive power in the second direction to condense light refracted by the second surface of the prism member, in the first direction and to be received to the first photodetector; and
a second condensing lens provided such that a refractive power in the first direction is greater than a refractive power in the second direction to condense light refracted by the first surface of the prism member, in the first direction and to be received to the second photodetector.

8. The three-dimensional distance information acquisition device of claim 7, wherein the receiving optical system further includes a second lens between the prism member and the first condensing lens, and a third lens between the prism member and the second condensing lens.

9. The three-dimensional distance information acquisition device of claim 7, wherein the first condensing lens and the second condensing lens independently include at least one of a rod-shaped lens with a round cross-section, a semi-cylindrical lens, a toric lens, and a freeform lens.

10. The three-dimensional distance information acquisition device of claim 3, wherein the receiving optical system includes:
a first lens on an incident side and configured to condense and receive the light reflected from the first and second scan areas;
a prism member having a greater thickness on a central axis of the first lens and have a first surface and a second surface inclined to each other on a side on which light passing through the first lens is incident; and
a condensing lens provided such that a refractive power in the first direction is greater than a refractive power in the second direction to condense light refracted by the first surface of the prism member, in the first direction and to be received to the second photodetector, and configured to condense light refracted by the second surface of the prism member, in the first direction and to be received to the first photodetector.

11. The three-dimensional distance information acquisition device of claim 10, wherein the receiving optical system further includes a second lens between the prism member and the condensing lens.

12. The three-dimensional distance information acquisition device of claim 10, wherein the condensing lens includes at least one of a rod-shaped lens with a round cross-section, a semi-cylindrical lens, a toric lens, and a freeform lens.

13. The three-dimensional distance information acquisition device of claim 3, wherein
the transmitter includes a light source including a plurality of light source elements arranged in a two-dimensional array, and a transmission optical system configured to cause light emitted from the light source to be irradiated to the scan area, and
the light source is configured to operate such that the light is irradiated to the first scan area and the second scan area simultaneously or at a different time in point unit or line unit.

14. The three-dimensional distance information acquisition device of claim 3, wherein
the transmitter includes a light source configured to emit light, and a transmission optical system configured to cause the light emitted from the light source to be irradiated to the scan area,
the transmission optical system includes a spatial light modulator including a plurality of pixels configured to steer incident light by phase modulation such that the incident light from the light source is steered and irradiated to the scan area in time division and configured to irradiate +n^{th}-order light and −n^{th}-order light respectively to the first scan area and the second scan area, where n is a natural number of 1 or more, and
each pixel of the spatial light modulator has a stacked structure including a first material layer, a cavity layer on the first material layer, and a second material layer arranged on the cavity layer, the stack structure having a grid structure.

15. The three-dimensional distance information acquisition device of claim 14, wherein the transmission optical system includes:
a collimating lens configured to collimate the light emitted from the light source; and
a diverging lens configured to expand a beam steering range by the spatial light modulator.

16. The three-dimensional distance information acquisition device of claim 1, wherein the transmitter includes a light source including a plurality of light source elements arranged in a two-dimensional array to emit light, and a transmission optical system configured to cause the light emitted from the light source to be irradiated to the scan area, and irradiates the light to the scan area in point unit or line unit.

17. The three-dimensional distance information acquisition device of claim 1, wherein the transmitter includes a light source configured to emit light, and a transmission optical system configured to cause the light emitted from the light source to be irradiated to the scan area,
the transmission optical system includes a spatial light modulator including a plurality of pixels configured to steer incident light by phase modulation such that the incident light from the light source is steered and irradiated to the scan area in time division, and
each pixel of the spatial light modulator has a stacked structure including a first material layer, a cavity layer on the first material layer, and a second material layer arranged on the cavity layer, the stack structure having a grid structure.

18. The three-dimensional distance information acquisition device of claim 17, wherein the transmission optical system includes:
a collimating lens configured to collimate the light emitted from the light source; and
a diverging lens configured to expand a beam steering range by the spatial light modulator.

19. An electronic device comprising at least one sensor selected from a distance sensor, a three-dimensional sensor, and a lidar sensor, and including the three-dimensional distance information acquisition device of claim 1 as the sensor.

20. The electronic device of claim 19, wherein
the sensor includes a mobile LiDAR sensor, and
the electronic device includes a mobile depth camera.
